(19) United States
(12) Patent Application Publication
(10) Pub. No.: US 2021/0394463 A1
(43) Pub. Date: Dec. 23, 2021

(54) PROCESS FOR IN-MOLD COATING OF COMPOSITE AIRCRAFT COMPONENTS

(71) Applicant: EMBRAER S.A., São José dos Campos - SP (BR)

(72) Inventors: Rogério de Almeida Silva, São José dos Campos - SP (BR); Edson da Silva Barbosa, São José dos Campos - SP (BR); João Paulo de Araujo Santana, São José dos Campos - SP (BR)

(21) Appl. No.: 16/907,931

(22) Filed: Jun. 22, 2020

(51) Int. Cl. B29C 70/54; B29C 43/14; B29C 70/06; B29C 70/46

(52) U.S. Cl. CPC B29C 70/54; B29C 43/146; B29K 2105/0881; B29C 70/46; B29C 2043/147; B29C 70/06

(57) ABSTRACT

Processes for forming composite aircraft components, i.e., aircraft components formed of a cured fiber-reinforced resin, are provided. According to specific embodiments, a finished surface of the composite aircraft component can be achieved by providing in-mold coating of the cured fiber-reinforced resin to thereby achieve a composite aircraft component having an exterior surface that does not necessarily require further finishing.

### FIELD

The embodiments disclosed herein relate generally to process for forming composite aircraft components, i.e., aircraft components formed of a cured fiber-reinforced resin. According to specific embodiments, a finished surface of the composite aircraft component can be achieved by providing in-mold coating of the cured fiber-reinforced resin to thereby achieve a composite aircraft component having an exterior surface that does not necessarily require further finishing.

### BACKGROUND

Composite materials formed of a cured fiber-reinforced resin material (e.g., cured carbon fiber reinforced epoxy) are well known in the fabrication of components for aircraft, e.g., flaps, ailerons, wing fuselage fairings, vertical and horizontal stabilizers, covers, interior parts and the like. Such components must however be painted in order to protect against the external environment, e.g., humidity, liquid leakage and the like.

One drawback to the use of composite materials is that they possess surface porosities due to the inherent nature of the conventional manufacturing processes. Aircraft components formed of a composite material must undergo pre-finish steps whereby a suitable filler material, e.g., pore filler, polyester filler or primer filler, is applied in order to correct surface defects and thereby obtain parts with the required smooth and aerodynamic surfaces. Such pre-finish steps will thereby necessarily increase production times and costs as well as expose operators to ergonomic issues since the filler material must be sanded to obtain the necessary surface quality for paint application.

It would therefore be highly desirable if composite aircraft components could be fabricated which avoid the pre-finish steps of the prior art processes. It is towards fulfilling such a need that the embodiments disclosed herein are directed.

### SUMMARY

Generally, the embodiments disclosed herein are directed toward a process whereby aircraft parts fabricated from a composite material (e.g., a cured fiber-reinforced resin material) may be subject to in-mold coating so that the cured component will exhibit the desired finished external surface when removed from the component mold.

According to specific embodiments, a process for making a composite aircraft component is provided whereby a contoured mold is provided so that a layer of a curable primer material may be applied onto an interior surface of the mold. The primer material is subsequently cured to form a cured layer of the primer material on the interior surface of the mold following which one or more prepreg layers of fiber reinforced uncured resin may be laid-up onto the cured primer layer to provide a component preform comprised of the mold having the cured layer of primer material and one or more prepreg layers thereon. The resulting preform may then be subjected to pressure and temperature conditions sufficient to cure the one or more prepreg layers and bond the prepreg layers to the cured layer of primer material and thereby form the composite aircraft component. Upon removal of the composite aircraft component from the mold, the cured layer of primer material will thereby form a finished surface of the composite aircraft component.

According to certain embodiments, the curable primer material (e.g., an epoxy paint) may be sprayed onto the interior surface of the mold. The prepreg layers may comprise reinforcement fibers selected from the group consisting of carbon, glass or aramid fibers impregnated with a curable resin, e.g., a curable epoxy resin.

These and other aspects and advantages of the present invention will become more clear after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is a schematic diagram depicting the steps according to an embodiment of the process according to the present invention;

FIG. 2 is a schematic view of the application of a curable primer onto an interior surface of a component mold;

FIG. 3 is a schematic view of the component mold depicted in FIG. 2 with a cured layer of the primer on the interior surface thereof;

FIG. 4 is a schematic view showing the lay-up of curable fiber-reinforced polymeric sheets onto the cured layer of the primer of the component mold depicted in FIG. 3;

FIG. 5 schematically depicts the component mold having layers of fiber-reinforced polymeric sheets laid up on the cured layer of the primer being subject to curing in a curing oven; and

FIG. 6 schematically shows the cured component de-molded from the component mold.

### DETAILED DESCRIPTION OF EMBODIMENTS

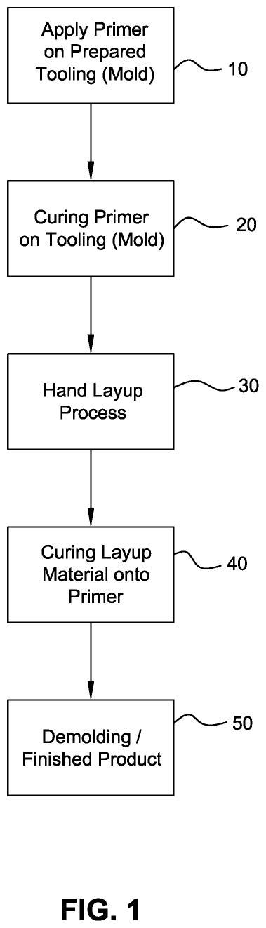

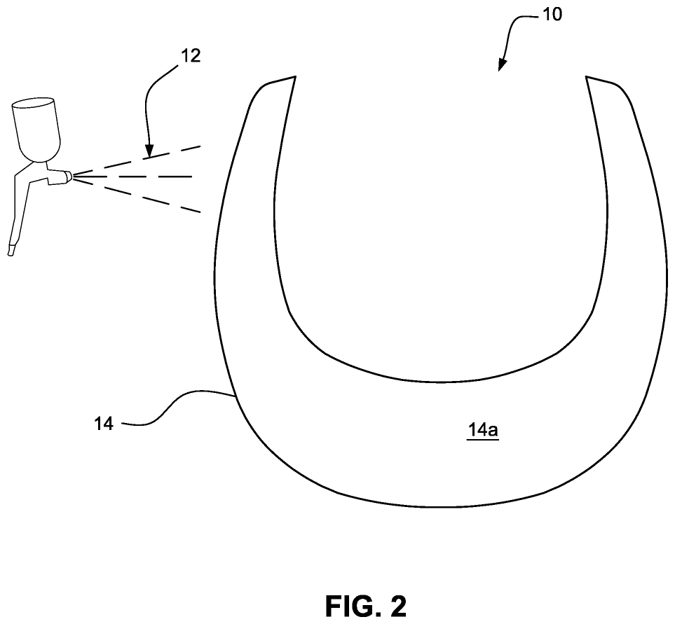

As is shown in FIG. 1 an embodiment of the process according to this invention involves a step 10 whereby a curable primer material onto the interior surface of a suitably configured mold (tooling). Accompanying FIG. 2 depicts step 10 whereby the curable primer material 12 may be sprayed onto the interior surface 14a of the mold 14. The primer material 12 can be any suitable curable material that is compatible with the fiber reinforced polymeric materials that are subsequently laid-up thereon. For example, the primer material 12 can be a curable epoxy paint that may contain pigments and other additives (UV inhibitors and the like) necessary for the external surface of the finished component.

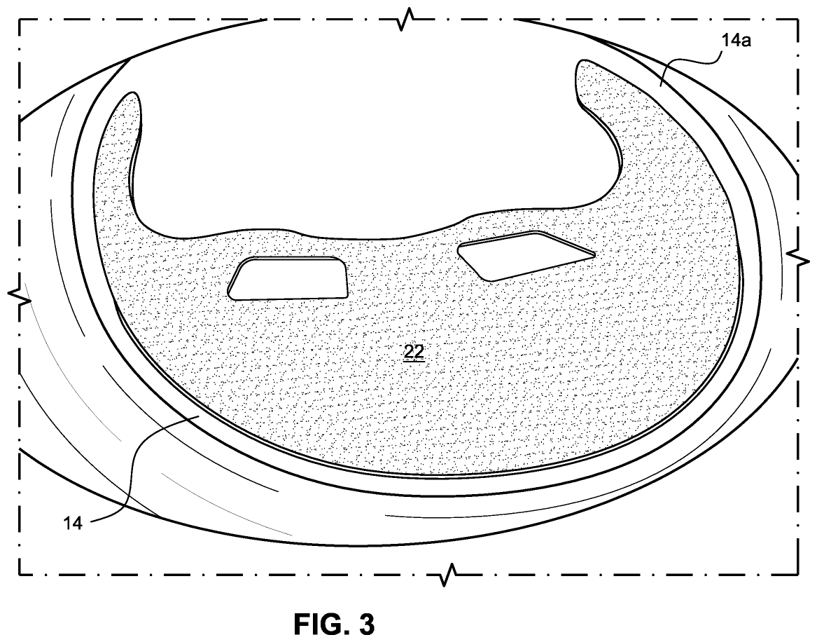

Once a suitable layer thickness (typically between about 60 μm to about 160 μm) of the primer material is applied onto the interior surface 14a of the mold 14, the mold can be cured according to step 20 (e.g., by placement in a curing oven) so as to cure the primer layer. The mold 14 containing a layer of the cured primer material (now designated as reference numeral 22) on the interior surface 14a of the mold 14 is depicted in accompanying FIG. 3.

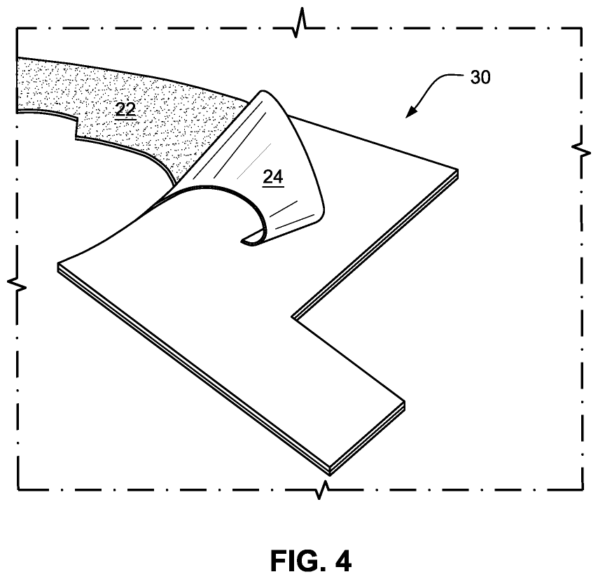

The cured layer 22 of primer material is maintained on the interior surface of the mold 14 so that operators can then apply in step 30 one or more layers or plies 24 of fiber-reinforced composite sheets. Such a lay-up procedure is schematically depicted in FIG. 4. As noted above, the uncured composite plies that may be employed according to the embodiments disclosed herein may be comprised of uncured (or partially cured) resin pre-impregnated carbon, glass or aramid fibers (i.e., so called “prepregs” in art parlance). The fibers of the prepreg plies will typically be oriented unidirectionally with respect to one another. In practice, therefore, there are typically several individual plies of curable fiber-reinforced prepregs 24 with adjacent layers being laid such that the fiber direction of one plie is biased or at an angle with respect to the fiber directions in adjacent plies so as to enhance strength of the resulting component. The curable fiber-reinforced prepregs 24 are laid up so as to achieve a desired thickness according to the design of the particular component being constructed.

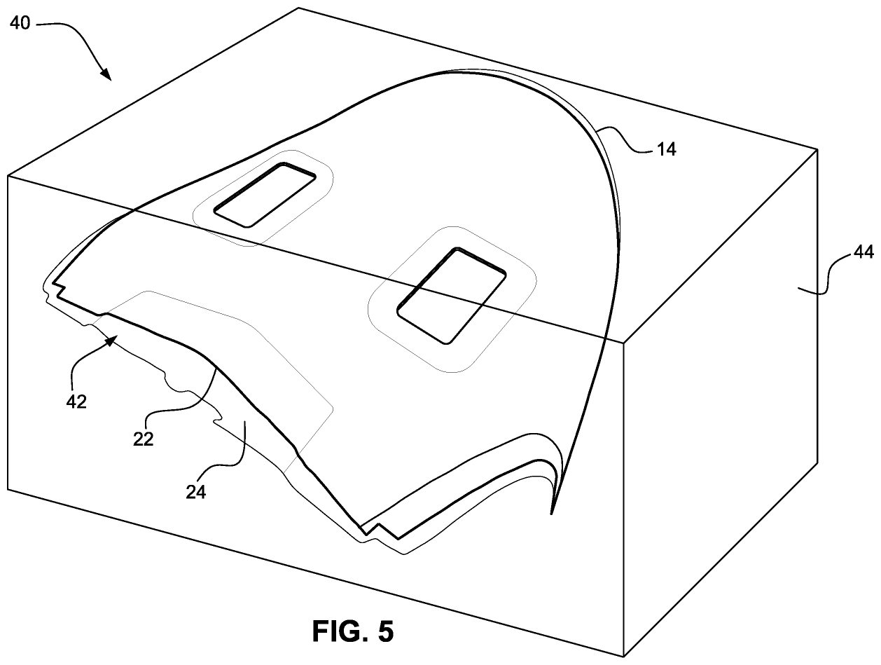

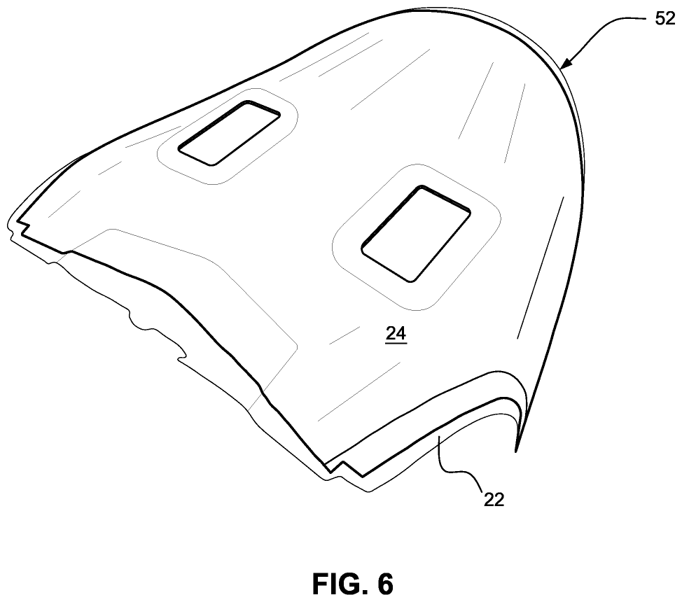

The preform designated by reference numeral 42 in FIG. 5 comprised of the mold 14, the cured primer layer 22 and the curable prepreg plies 24 may then be cured, for example, within a curing oven 44 in step 40. Curing of the prepreg plies 24 is therefore accomplished under suitable elevated pressure and temperature conditions to achieve fully curing of the resin in the prepreg plies 24 and thereby bond the plies one to another and to the cured primer layer 22. Upon demolding in step 50, a finished component designed by reference numeral 52 in FIG. 6 is achieved. Specifically, the component 52 will include a finished external surface comprised of the cured primer layer 22 which is bonded to the cured prepreg plies 24 on the interior surface thereof. As such, the component 52 will not possess the typical defects associated with conventional processes but instead will have a finished exterior surface that does not necessarily require the application of any fillers and subsequent sanding. Additionally, the cured primer layer 22 does not necessarily need to be painted if it contains suitable pigment coloring needed for the finished component 52.

While reference is made to a particular embodiment of the invention, various modifications within the skill of those in the art may be envisioned. Therefore, it is to be understood that the invention is not to be limited to the disclosed embodiment, but on the contrary, is intended to cover various modifications and equivalent arrangements included within the spirit and scope thereof.

What is claimed is:

1. A process for making a composite aircraft component comprising:
(a) providing a contoured mold;
(b) applying a layer of a curable primer material onto an interior surface of the mold;
(c) curing the primer material to form a cured layer of the primer material on the interior surface of the mold;
(d) applying one or more prepreg layers of fiber reinforced uncured resin to provide a component preform comprised of the mold having the cured layer of primer material and one or more prepreg layers thereon;
(e) subjecting the preform to pressure and temperature conditions sufficient to cure the one or more prepreg layers and bond the prepreg layers to the cured layer of primer material and thereby form the composite aircraft component.

2. The process according to claim 1, further comprising the step of removing the composite aircraft component from the mold so that the cured layer of primer material forms a finished surface of the composite aircraft component.

3. The process according to claim 1, wherein step (b) comprises spraying the curable primer material onto the interior surface of the mold.

4. The process according to claim 3, wherein the primer material is an epoxy paint.

5. The process according to claim 4, wherein the step (b) is practiced to form a primer layer which has a thickness of between about 60 μm to about 160 μm.

6. The process according to claim 1, wherein the one or more prepreg layers comprise reinforcement fibers selected from the group consisting of carbon, glass or aramid fibers impregnated with a curable resin.

7. The process according to claim 5, wherein the one or more prepreg layers comprises carbon fibers impregnated with a curable epoxy resin.

8. The process according to claim 6, wherein step (b) comprises spraying the curable primer material onto the interior surface of the mold.

9. The process according to claim 7, wherein the primer material is an epoxy paint.

10. The process according to claim 8, wherein the step (b) is practiced to form a primer layer which has a thickness of between about 60 μm to about 160 μm.
